(19) United States
(12) Patent Application Publication
(10) Pub. No.: US 2006/0202180 A1
(43) Pub. Date: Sep. 14, 2006

(54) RESCUE TOOL ASAPTERS AND METHODS OF USING SAME

(76) Inventors: John E. McLoughlin, Lake Grove, NY (US); Neocles G. Athanasiades, Setauket, NY (US); Toh M. Meng, Hauppauge, NY (US)

Correspondence Address: Frank L. Hart;Attorney at Law, 8911 S. 73rd East Ave., Tulsa, OK, 74133, US

(21) Appl. No.: 11/075,215

(22) Filed: Mar. 9, 2005

(51) Int. Cl. A62B 3/00

(52) U.S. Cl. 254/93 R

(57) ABSTRACT

Adapters and methods are provided for utilization on a powered two armed rescue tool for opening metal doors. The adapter has a first end portion of general “U” configuration which is hooked over a door. The adapter is connected to one arm of the powered rescue tool and the other arm is positioned in contact with the frame of the door. The powered rescue tool is then actuated which causes the arms to separate and force the door open.

### BACKGROUND OF THE INVENTION

1. Field of the Invention

The subject invention relates to adapters for two armed powered rescue tools and the methods of using them.

More specifically, the subject invention relates to adapters of two different constructions for connection to one arm of a powered rescue tool and the methods of using the adapters with the powered rescue tool to open a metal door.

2. Description of Related Art including Information Disclosed under 37 CFR 1.97 and 1.98

Two armed powered rescue tools are well known in the art. They are sometimes referred to as “The Jaws of Life” and by other names. They have various attachments or adapters that are connectable to one of the arms of the tool. The rescue tools are helpful in prying, cutting and squeezing metal in order to gain access to the interior, for example the interior of a vehicle.

The subject adapter is specifically constructed for use with the powered rescue tools and have been found to be highly efficient for use in prying open a metal door.

### BRIEF SUMMARY OF THE INVENTION

In one aspect of the invention, a rescue tool adapter is provided for a powered two armed rescue tool utilized for opening metal doors. The adapter has first and second end portions. The first end portion is of general “U” configuration and has first and second legs. The first and second legs are spaced apart a distance greater than the thickness of a door to be opened. The second end portion is connectable to one of the arms of a rescue tool at one end and is connected to the adapter second end portion at the other end.

In another aspect of the invention, a method of using the adapter is described. In this method of using, the adapter set forth immediately above is selected and installed on one leg of the powered rescue tool. The first end portion of the adapter is then hooked over the door and the second rescue tool arm is placed in contact with the door frame at a location spaced from said door. The powered rescue tool is then actuated.

### BRIEF DESCRIPTION OF THE SEVERAL VIEWS OF THE DRAWING(S)

FIG. 1 is a partial top view of a powered two armed rescue tool with the adapter of this invention installed thereon;

FIG. 2 is a frontal view of a portion of the adapter in position over a door;

FIG. 3 is a partial view of the second leg of the first end portion and an extension of the adapter of this invention;

FIG. 4 is a partial sectional view of a connection of the adapter to the rescue tool arm; and

FIG. 5 is a partial sectional view of another embodiment of the adapter having a body extension.

### DETAILED DESCRIPTION OF THE INVENTION

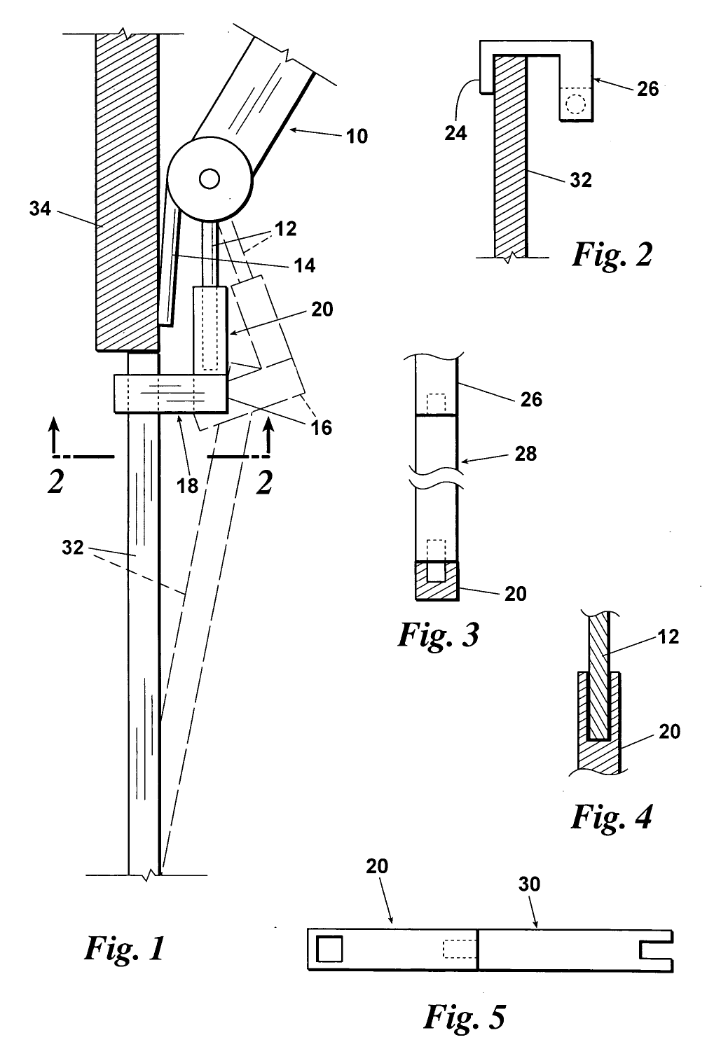

Referring to FIG. 1, a powered rescue tool 10, as well known in the art, has first and second arms 12,14. Upon actuation of the rescue tool 10, one of the arms pivotally moves outwardly and away from the other arm. The adapter 16 of this invention is here shown installed on the first arm 12 of the rescue tool 10.

Referring to FIGS. 1-3, the adapter 16 has first and second end portions 18,20. The first end portion 18 is of a general “U” configuration having first and second legs 24,26, as shown in FIG. 2. As can be seen, in the preferred embodiment, the second leg 26 is of greater length than the first leg 24.

By providing the apparatus of this invention with a second leg 26 of longer and varying dimensions, an operator can position the second arm 14 of the powered rescue tool at the most advantageous location for exerting force on the door. This is an important aspect of the adapter in that, as is known, in vehicle accidents, doors and door frames become quite distorted resulting in varying positions at which the door can be most conveniently and efficiently opened.

Referring to FIG. 3, a second leg extension 28 is shown. The second leg extension 28 can be formed with various lengths. One end of the second leg extension 28 is connectable to the second leg 26 and the other end is connected to the second end portion 20 of the adapter 16. It should be understood that adapters 16 can be formed with the second leg 26 being of unitary construction while providing a plurality of second leg lengths for having greater flexibility.

The first and second legs 24,26 are spaced apart a distance greater than the thickness of a door to be opened. The second end portion 20 of the adapter 16 is of a construction to be connectable at one end to one of the arms 12 of the powered rescue tool 10 and connected at the other end to the first end 18 portion of the adapter.

For reasons as describe above with reference to FIG. 3, the second end portion of the adapter can also be advantageously provided with a body extension 30, as shown in FIG. 5. The body extension 30 is connectable at one end to the first end portion 18 of the adapter 16 and is connectable at the other end to the first arm 12 of the power rescue tool.

In the method of opening a door 32 with a powered rescue tool 10 comprises selecting one of the rescue tool adapters 16 as set forth above, assembling and installing the rescue tool adapter 16 on one arm 12 of the powered rescue tool 10. The first end portion for the adapter 16 is hooked over the door 32 and the second arm 14 is positioned in contact with the door frame 34 at a location spaced from the door 32. The powered rescue tool 10 is then actuated.

Other aspects, objects and advantages will become apparent from a study of the drawings, the specification and appended claims.

1. A rescue tool adapter for a powered two armed rescue tool utilized for opening metal doors,
said adapter having first and second end portions,
said first end portion being of general “U” configuration having first and second legs, said first and second legs being spaced apart a distance greater than the thickness of a door to be opened, and
said second end portion being connectable to one of the arms of a rescue tool at one end and being connected to the adapter first end portion at the other end.

2. A rescue tool adapter, as set forth in claim 1, wherein the length of the second end portion of the adapter is sufficient for forming a rescue tool with the arm having the adapter installed being longer than the other rescue tool arm.

3. A rescue tool adapter, as set forth in claim 1, including a leg extension being connectable at one end to the second leg of the first end portion of the adapter 16 and at the other end to the second end portion of the adapter.

4. A rescue tool adapter, as set forth in claim 3, including a body extension for the second end portion of the adapter, said body extension being connectable at one end to the first arm of the powered rescue tool and at the other end to the second end portion of the adapter.

5. A rescue tool adapter, as set forth in claim 4, including a body extension for the second end portion of the adapter, said body extension being connectable at one end to the first arm of the powered rescue tool and at the other end to the sedcond end portion of the adapter.

6. A method of using a rescue tool, comprising:
selecting the rescue tool adapter of claim 1;
installing the rescue tool adapter on one arm of the powered rescue tool;
hooking the first end portion of the rescue tool adapter over the door and positioning the second powered rescue tool arm in contact with the door frame at a location spaced from said door; and
actuating the powered rescue tool.

7. The method, as set forth in claim 6, including a leg extension connectable at one end to the second leg of the first end portion of the adapter and at the other end to the second end portion of the adapter and
connecting one end of the leg extension to the second leg of the first end portion of the adapter and defining an assembled adapter.

8. The method, as set forth in claim 7, including a body extension connectable at one end to the first arm of the powered rescue tool and at the other end to the second end portion of the adapter and
connecting the body extension to the second end portion of the adapter and defining an assembled adapter.

9. The method, as set forth in claim 6, including a body extension connectable at one end to the first arm of the powered rescue tool and at the other end to the second end portion of the adapter and
connecting the body extension to the second end portion of the adapter and defining an assembled adapter.
